(19) United States
(12) Patent Application Publication
(10) Pub. No.: US 2019/0258728 A1
(43) Pub. Date: Aug. 22, 2019

(54) FOOTERS FOR COMPRESSED OBJECTS

(71) Applicant: Hewlett Packard Enterprise Development LP, Houston, TX (US)

(72) Inventor: Glenn Watkins, Westborough, MA (US)

(21) Appl. No.: 15/902,329

(22) Filed: Feb. 22, 2018

(51) Int. Cl. G06F 17/30

(52) U.S. Cl. CPC G06F 17/30153; G06F 17/30371; G06F 17/30156

(57) ABSTRACT

In example implementations, an apparatus is provided. The apparatus includes a processor and a non-transitory computer readable storage medium encoded with instructions executable by a processor. The non-transitory computer readable storage medium includes instructions to apply a compression method to compress data into a compressed object, wherein the compression method is different than other compression methods used by other nodes within a storage network, instructions to generate a footer that includes an uncompressed data signature and a compressed data signature for the compressed object to provide verification of the compressed object for the other nodes without decompressing the compressed object at the other nodes, and instructions to add the footer in the compressed object.

### BACKGROUND

Large amounts of data are created by a variety of different devices and computing systems around the world. Some businesses may want to store and manage the large amounts of data. Many businesses offload the responsibility of storing the data to third party network storage service providers. In some cases, the businesses may pay for the service, which may be cheaper than investing in the hardware, maintenance, and real estate to build their own network storage facility.

Storage networks may use different protocols to store, manage, and move data that is stored in the physical drives within the storage networks. Data can be replicated for redundancy in case of a failure of a physical drive or to provide faster access for data that is frequently accessed. Data can be moved to be stored on a physical drive that is closer to a customer. Data can be managed to deduplicate the data to minimize the consumption of storage resources.

### BRIEF DESCRIPTION OF THE DRAWINGS

FIG. 1 is a block diagram of an example network of the present disclosure;

FIG. 2 is a block diagram of an example apparatus of the present disclosure;

FIG. 3 is a flow chart of an example method for generating a footer for a compressed object; and

FIG. 4 is a block diagram of an example non-transitory computer readable storage medium storing instructions executed by a processor.

### DETAILED DESCRIPTION

Examples described herein provide footers for compressed objects that improve processing of compressed objects in a data storage network. As discussed above, storage networks may use different protocols to store, manage, and move data that is stored in the physical drives within the storage networks. Data can be replicated for redundancy in case of a failure of a physical drive or to provide faster access for data that is frequently accessed. Data can be moved to be stored on a physical drive that is closer to a customer. Data can be managed to deduplicate the data to minimize the consumption of storage resources.

In some implementations, each node in a data storage network has the same hardware capabilities. However, data storage networks may be built to include nodes with different hardware capabilities. If the nodes within the data storage network have different hardware capabilities, objects stored in the data storage network may not be able to be processed by all of the nodes. In addition, compressed objects may be decompressed to verify that the data is the correct and that the correct object was processed.

The footer of the present disclosure that is added to the compressed objects allows different nodes with different hardware capabilities to process any compressed object regardless of what compression method was applied to the data. Different types of data may be amenable to different compression methods. Thus, the compression method that is used for different types of data may be tracked and contained in the footer.

Moreover, the footer provides more efficient handling of compressed objects within the data storage network. The footer may include information that can be used by the nodes to ensure that the compressed object has not been corrupted and verify that the compressed object is the correct object that is being operated on.

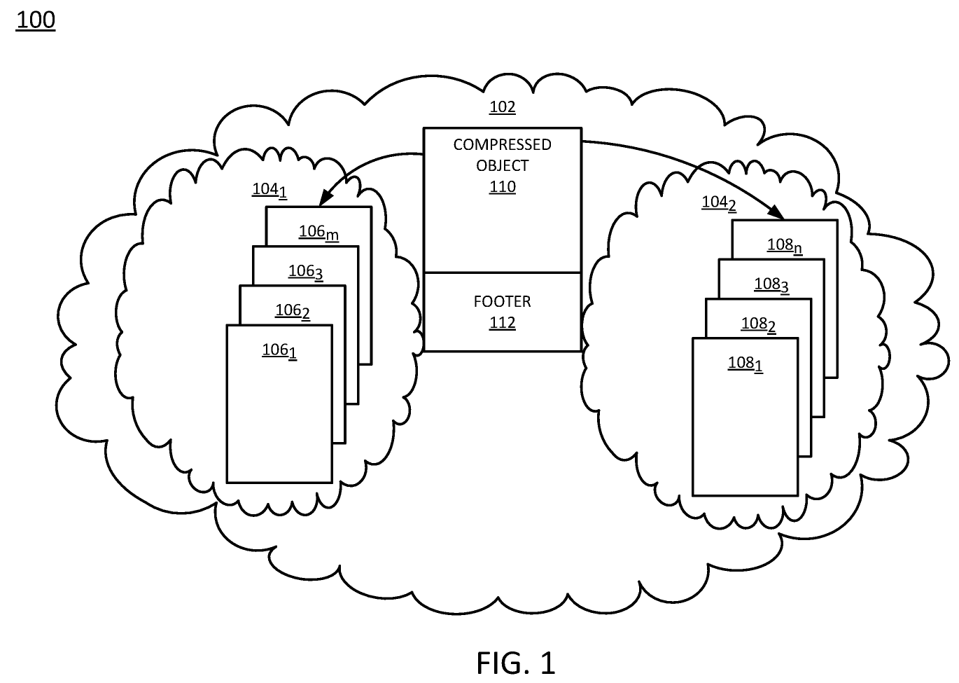

FIG. 1 illustrates a data storage network 100 of the present disclosure. In an example, the data storage network 100 may include a plurality of nodes 106₁ to 106ₘ (also referred to herein individually as a node 106 or collectively as nodes 106) and a plurality of nodes 108₁ to 108ₙ (also referred to herein individually as a node 108 or collectively as nodes 108). The nodes 106 may be grouped into a cluster 104₁ and the nodes 108 may be grouped into a cluster 104₂. The clusters 104₁ and 104₂ may be grouped into a federation 102.

Although two clusters 104₁ and 104₂ are illustrated in FIG. 1, it should be noted that any number of clusters 104 may be deployed. In addition, the number of nodes 106 and 108 within each cluster 104₁ and 104₂ may be the same number or a different number of nodes.

In an example, each node 106 and 108 may represent one or more servers at a particular location. The clusters 104₁ and 104₂ may represent different regions. The federation 102 may represent the entire network of a service provider that manages the data storage network 100.

In an example, each node 106 and 108 may be a server that is in communication with a plurality of physical hard drives or storage drives. Each node may execute an instance of an object management process that receives data, transforms the data into an object, and stores and manages the objects. For example, the object management process may include blocks of instructions that receive data from customers over a network and then process the data into objects that are stored at the nodes 106 or 108 within the data storage network 100.

In an example, some or all nodes may have an object store. An object store may include an index that identifies each object that is stored within the physical disks of a particular node. The object store may store object records. In an example, the nodes 106 and 108 may perform deduplication such that a single instance of unique object records are stored in the object store.

In an example, a compression method may be applied to the data by the nodes 106 and 108 to compress the data into the compressed object 110. The compression method may include hardware compression using separate hardware compression devices or software compression such as DEFLATE, LZO, LZ4, and the like. A cryptographic hash function may be applied by the nodes 106 or 108 to data to calculate a hash value for the compressed object.

An object signature may be created for the object that is uncompressed. The object signature may include a hash value of the object. In some implementations, the object signature may include the hash value, a size of the uncompressed object, and a type of data that is in the uncompressed object. The object signature may then be included in the object record which includes the object signature, a reference count, and an address. In other words, for each instance that the object signature is obtained, the reference count may be increased. The address may locate where in the physical drives of the nodes 106 or 108 the compressed object is stored. The object records for each object signature may be stored in the index of the object store.

In an example, the nodes 106 and 108 may have different hardware capabilities. For example, nodes 106₁ and 108₁ may have separate hardware components that perform hardware compression. Nodes 106₂ and 108₂ may not have the hardware components to perform hardware compression, but may perform software compression. Nodes 106₃ and 108₃ may perform different software compression methods than nodes 106₂ and 108₂, and so forth.

It should be noted that although the nodes 106 and 108 may perform different compression methods, that the nodes 106 and 108 perform the same compression protocol. The compression protocol may relate to the sequence of steps that are performed. For example, the compression protocol may include pre-processing data before a particular compression method is applied and post-processing the compressed data object 110.

In an example, each nodes 106₁-106ₘ and 108₁-108ₙ may be able to perform any decompression method. In other words, although nodes 106 and 108 may have different compression capabilities, each node 106₁-106ₘ and 108₁-108ₙ may have the same set, or a common set, of decompression capabilities.

As noted above, data within the data storage network 100 may be stored and managed as a compressed object 110. In an example, a footer 112 may be added to each compressed object 110. The compressed object 110 may be moved from one node to another node (e.g., from node 108₁ to node 1061, or node 108₁ to node 108₂, and the like) for a variety of different reasons. For example, the compressed object 110 may be moved to a node 106 or 108 that is closer to a customer to improve access times. The compressed object 110 may be replicated on another node 106 or 108 for redundancy in case of a failure of a physical drive in a node 106 or 108.

The footer 112 may be generated by a node 106 or 108 when the data is compressed to create the compressed object 110. In an example, the footer 112 may include a compressed data signature and an uncompressed data signature. The compressed data signature may be used by nodes 106 or 108 that receive the compressed object 110 to verify an integrity of the compressed object 110. In an example, the compressed data signature may be a checksum value. The checksum value may be used to protect against data corruption as the compressed object 110 is moved around within a node 106 or 108 or between different nodes 106 and 108 within the data storage network 100.

The uncompressed data signature may be used by nodes 106 or 108 that receive the compressed object 110 to verify that the correct object is being operated on. In an example, the uncompressed data signature may include an object signature that includes a hash value of the uncompressed object. In an example, the uncompressed data signature may be an object signature described above that includes a hash value resulting from an applied cryptographic hash, a size of the uncompressed object, and a type of data that is in the uncompressed object. A receiving node 106 or 108 may request or expect to receive a particular object having certain data. The object signature may be compared to the object signature of the object the receiving node 106 or 108 is expecting to confirm that the correct compressed object 110 is received. Notably, the receiving node 106 or 108 does not need to decompress the data to examine the raw data to verify that the correct data is received. As a result, the compressed data signature and the uncompressed data signature in the footer 112 allows the compressed object 110 to be processed more efficiently by any of the nodes 106 or 108.

In an example, the footer 112 may also include a fixed known value (also referred to as a “magic number”), a version number, an identification of a compression method that was applied, and a compressed data size. The fixed known value may allow the nodes 106 or 108 to locate the footer 112 within the compressed object 110. The fixed known value may be predefined and the nodes 106 and 108 may know the fixed known value for where the footer 112 may be located within the compressed object 110.

The version number may allow the nodes 106 and 108 to know which version of the footer 112 is being used. For example, as the footer 112 evolves with different iterations, the version number may allow the nodes 106 and 108 to apply or read the footer 112 with the appropriate version.

The identification of the compression method and the compressed data size may provide information to allow any node 106 or 108 to decompress the data. As noted above, the nodes 106 and 108 may have different hardware or compression capabilities. However, the nodes 106 and 108 may all have the same set, or a common set, of decompression capabilities. Thus, the identification of the compression method and the compressed data size may allow the nodes 106 and 108 to decompress the compressed object 110 with the correct decompression method.

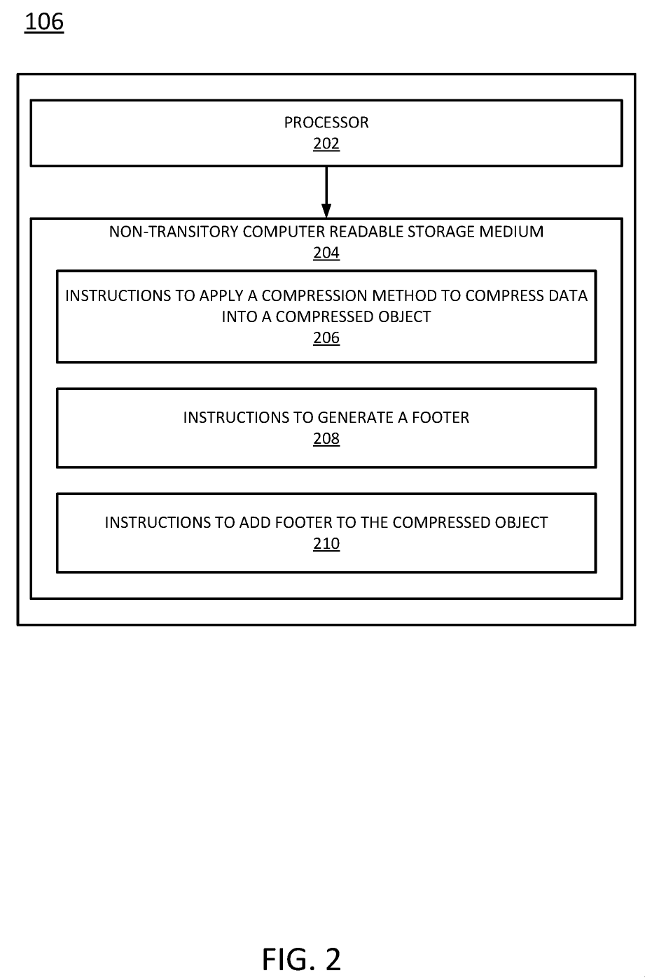

FIG. 2 illustrates an example of a node 106 that can generate a footer 112 and transmit a compressed object 110 with the footer 112. It should be noted that the example illustrated in FIG. 2 may also be any of the nodes 108. In an example, the node 106 may include a processor 202 and a non-transitory computer readable medium 204. The non-transitory computer readable medium 204 may store instructions that are executed by the processor 202.

In an example, the instructions may include instructions 206, 208, and 210. The instructions 206 may include instructions to apply a compression method to compress data into a compressed object. The compression method may be different than other compression methods used by other nodes 106 and 108 in the data storage network 100. In an example, the compression method may include applying a cryptographic hash function to the data to obtain a hash value and a checksum value. The hash value may be stored as part of the object signature of the compressed object 110, as described above, and tracked via an object record stored in an index of an object store.

The instructions 208 may include instructions to generate a footer (e.g., the footer 112). The footer may include an uncompressed data signature and a compressed data signature for the compressed object 110 to provide verification of the compressed object 110 for the other nodes 106 and 108 without decompressing the compressed object 110 at the other nodes 106 and 108. As described above, the compressed data signature may include the checksum value that verifies an integrity of the compressed object 110. In other words, the checksum value may be used to prevent data corruption in the compressed object 110.

In an example, the uncompressed data signature may include the object signature. The hash value of the object signature may be used by a receiving node 106 or 108 and compared to the expected hash value of the expected object signature. Thus, the receiving node 106 or 108 may verify that the correct object is being operated on without decompressing the compressed object 110 and hashing the decompressed object.

In an example, the footer 112 may include additional information such as a fixed known value, a version number, an identification of the compression method that was applied, and a compressed data size. The additional information may be used by the receiving node 106 or 108 to locate the footer 112 in the compressed object 110 and to properly decompress the compressed object 110 into the raw data.

The instructions 210 may include instructions to add the footer 112 to the compressed object 110. The footer 112 may be stored in a particular location in the compressed object 110 in accordance with the fixed known value.

It should be noted that FIG. 2 has been simplified for ease of explanation. For example, the nodes 106 and 108 may also include instructions to process transferred compressed objects (e.g., compressed objects received from other nodes 106 and 108). For example, the nodes 106 and 108 may include instructions to receive the transferred compressed objects from another node and process the transferred compressed object with a respective footer in the transferred compressed object. The nodes 106 and 108 may process the transferred compressed object by locating the respective footer and verifying an integrity of the transferred compressed object with a respective compressed data signature and a respective uncompressed data signature.

The nodes 106 and 108 may include additional components that are not shown. For example, the nodes 106 and 108 may include communication interfaces to establish a wired or wireless communication path with other nodes 106 and 108, a hardware component for hardware compression, an interface for connecting physical drives, an input/output interface to connect external displays or external input devices (e.g., a mouse, keyboard, and the like), and so forth.

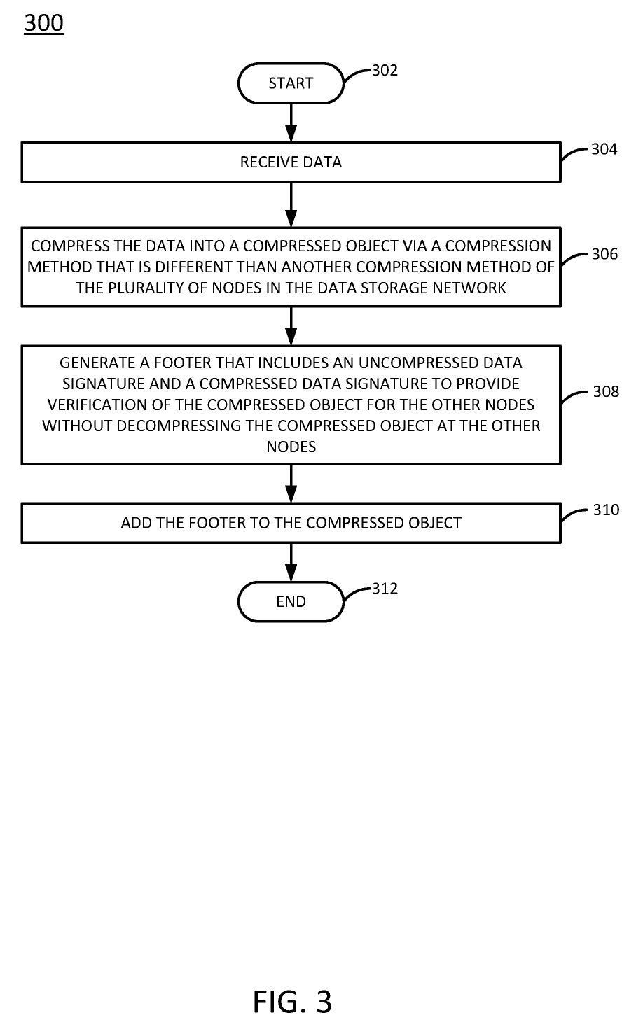

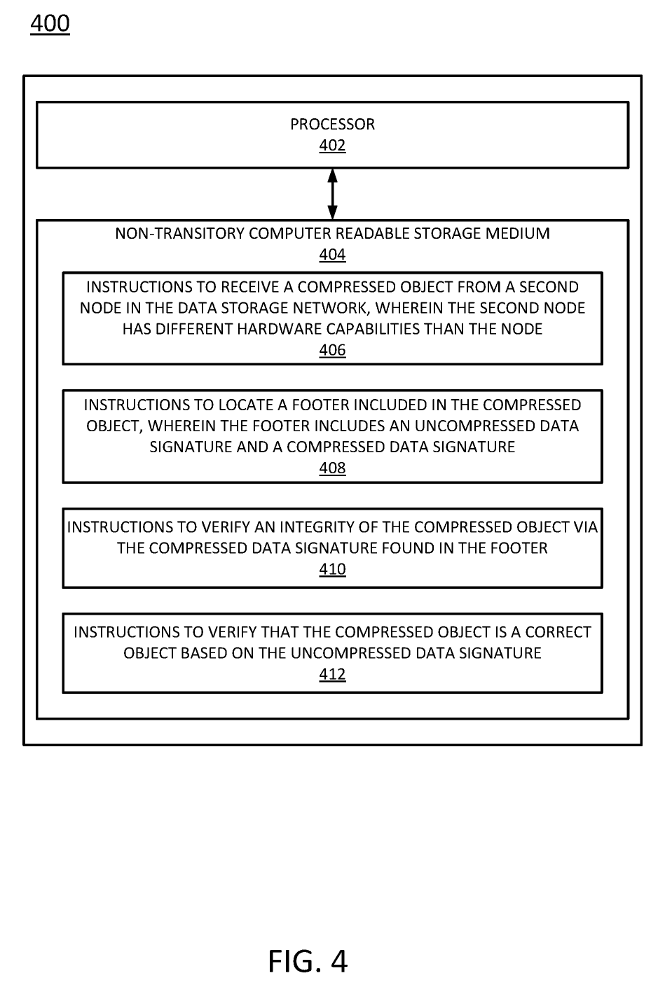

FIG. 3 illustrates a flow diagram of an example method 300 for generating a footer for a compressed object. In an example, the method 300 may be performed by the nodes 106 or 108 or the apparatus 400 illustrated in FIG. 4 and described below.

At block 302, the method 300 begins. At block 304, the method 300 receives data. For example, the data may be received by a node in a data storage network comprising a plurality of nodes. The data may be received over a network from a customer of the data storage network to be stored in the data storage network. The plurality of nodes in the storage network may have different hardware capabilities or compression capabilities, but have the same decompression capabilities.

At block 306, the method 300 compresses the data into a compressed object via a compression method that is different from another compression method of the plurality of nodes in the data storage network. The data storage network may manage and process data as objects. The objects may be compressed objects that have an object signature. The object signature may be stored as an object record with a reference counter and an address of a location of the compressed object on a physical drive. The object record may be stored in an index of an object store of a particular node.

At block 308, the method 300 generates a footer that includes an uncompressed data signature and a compressed data signature to provide verification of the compressed object for the other nodes without decompressing the compressed object at the other nodes. As noted above, the nodes may have different compression capabilities. Thus, without the footer, a node with a different compression capability from the node that compressed the compressed object may not be able to process the compressed object. However, the footer of the present disclosure allows any receiving node to process the compressed object without having to decompress the compressed object. In addition, the footer allows any receiving node to properly decompress the compressed object.

In an example, the compressed data signature may be used by a receiving node to verify an integrity of the compressed object. For example, the compressed data signature may be a checksum value that is used to protect against data corruption as the compressed object is moved from node to node within the data storage network.

In an example, the uncompressed data signature may be used by a receiving node to verify that the correct object is being operated on. For example, the uncompressed data signature may be an object signature described above that includes a hash value resulting from an applied cryptographic hash of the object. In other implementations, the object signature may include a hash value, a size of the uncompressed object, and a type of data that is in the uncompressed object. A receiving node may request or expect to receive a particular object having certain data. The object signature may be compared to the object signature of the object the receiving node is expecting to confirm that the correct compressed object is received. Notably, the receiving node does not need to decompress the data to examine the raw data to verify that the correct data is received. As a result, the compressed data signature and the uncompressed data signature in the footer allows the compressed object to be processed more efficiently by any of the nodes.

The footer may also include additional information that can be used by a receiving node to locate the footer in the compressed object and correctly decompress the compressed object. For example, the footer may also include a fixed known value, a version number, an identification of a compression method that was applied, and a compressed data size.

At block 310, the method 300 adds the footer to the compressed object. The footer may be stored in a particular location in the compressed object in accordance with the fixed known value.

In an example, the compressed object may be transmitted to another node. For example, the compressed object may be moved or may be replicated for redundancy at a second node. The second node may have different hardware capabilities from the node that compressed the data and generated the footer. The footer may be used by the second node to verify an integrity of the compressed object and that the compressed object is the correct object. At block 312, the method 300 ends.

FIG. 4 illustrates an example of an apparatus 400. In an example, the apparatus 400 may be a node 106 or 108 that receives a compressed object 110 with a footer 112 illustrated in FIG. 1. In an example, the apparatus 400 may include a processor 402 and a non-transitory computer readable storage medium 404. The non-transitory computer readable storage medium 404 may include instructions 406, 408, 410, and 412 that, when executed by the processor 402, cause the processor 402 to perform various functions.

In an example, the instructions 406 may include instructions to receive a compressed object from a second node in the data storage network, wherein the second node has different hardware capabilities than the node. The instructions 408 may include instructions to locate a footer included in the compressed object, wherein the footer includes an uncompressed data signature and a compressed data signature. The instructions 410 may include instructions to verify an integrity of the compressed object via the compressed data signature found in the footer. The instructions 412 may include instructions to verify that the compressed object is a correct object based on the uncompressed data signature.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
a processor; and
a non-transitory computer readable storage medium encoded with instructions executable by a processor, the non-transitory computer-readable storage medium comprising:
instructions to apply a compression method to compress data into a compressed object, wherein the compression method is different than other compression methods used by other nodes within a storage network;
instructions to generate a footer that includes an uncompressed data signature and a compressed data signature for the compressed object to provide verification of the compressed object for the other nodes without decompressing the compressed object at the other nodes; and
instructions to add the footer in the compressed object.

2. The apparatus of claim 1, wherein the apparatus and the other nodes comprise a common set of decompression capabilities.

3. The apparatus of claim 1, wherein the uncompressed data signature comprises an object signature to verify that the compressed object is a correct object.

4. The apparatus of claim 1, wherein the compressed data signature comprises a checksum value that protects against data corruption as the compressed object is moved to different nodes by verifying that a buffer of the compressed object is intact.

5. The apparatus of claim 1, wherein the non-transitory computer-readable storage medium further comprises:
instructions to receive a transferred compressed object from another node; and
instructions to process the transferred compressed object with a respective footer in the transferred compressed object.

6. The apparatus of claim 5, wherein the instructions to process comprise verifying an integrity of the transferred compressed object via a respective compressed data signature in the respective footer.

7. The apparatus of claim 5, wherein the instructions to process comprise verifying that a correct compressed object is being decompressed via a respective uncompressed data signature in the respective footer and decompressing the transferred compressed object into decompressed data via an identification of a compression method used to compress the transferred compressed object in the respective footer.

8. A method, comprising:
receiving, by a processor of a node in a data storage network comprising a plurality of nodes, data;
compressing, by the processor, the data into a compressed object via a compression method that is different than another compression method of the plurality of nodes in the data storage network;
generating, by the processor, a footer that includes an uncompressed data signature and a compressed data signature to provide verification of the compressed object for other nodes without decompressing the compressed object at the other nodes; and
adding, by the processor, the footer to the compressed object.

9. The method of claim 8, further comprising:
transmitting, by the processor, the compressed object with the footer to a second node in the data storage network, wherein the second node has a different hardware capability than the node.

10. The method of claim 9, wherein an integrity of the compressed object is verified by the second node with the compressed data signature that verifies that a buffer of the compressed object is intact.

11. The method of claim 9, wherein the second node verifies that the compressed object is a correct object via the uncompressed data signature.

12. The method of claim 8, wherein the compressed data signature comprises a checksum.

13. The method of claim 8, wherein the uncompressed data signature comprises an object signature.

14. The method of claim 8, wherein the footer includes a fixed known value that identifies a location of the footer in the compressed object.

15. The method of claim 8, wherein the footer includes identification of a compression method and a compressed data size of the compressed object.

16. A non-transitory computer readable storage medium encoded with instructions executable by a processor of a node in a data storage network, the non-transitory computer-readable storage medium comprising:
instructions to receive a compressed object from a second node in the data storage network, wherein the second node has different hardware capabilities than the node;
instructions to locate a footer included in the compressed object, wherein the footer includes an uncompressed data signature and a compressed data signature;
instructions to verify an integrity of the compressed object via the compressed data signature found in the footer; and
instructions to verify that the compressed object is a correct object based on the uncompressed data signature.

17. The non-transitory computer readable storage medium of claim 16, wherein the uncompressed data signature comprise an object signature.

18. The non-transitory computer readable storage medium of claim 16, further comprising:
instructions to decompress the compressed object based on an identification of a compression method and a compressed data size of the compressed object that are provided by the footer.

19. The non-transitory computer readable storage medium of claim 16, wherein the node and the second node comprise a same plurality of decompression capabilities.

20. The non-transitory computer readable storage medium of claim 16, wherein the instructions to locate is based on a fixed known value in the footer.
